(19) United States
(12) Patent Application Publication
(10) Pub. No.: US 2023/0162274 A1
(43) Pub. Date: May 25, 2023

(54) RELATED ITEM DETERMINATION AND CONTENT SELECTION BASED UPON RELATED ITEMS

(71) Applicant: Verizon Media Inc., New York, NY (US)

(72) Inventors: Xiao Bai, San Jose, CA (US); Richard Hin-Fai Tang, Saratoga, CA (US); Ritesh Kumar Shyam Sunder Agrawal, Santa Clara, CA (US); Gaurav Batra, Cupertino, CA (US); Lei Duan, San Jose, CA (US)

(21) Appl. No.: 17/530,631

(22) Filed: Nov. 19, 2021

(51) Int. Cl. G06Q 30/08; G06Q 30/06

(52) U.S. Cl. CPC G06Q 30/08; G06Q 30/0643

(57) ABSTRACT

In an example, a first item of a plurality of items may be identified. A set of items related to the first item may be determined based upon first item information associated with the first item. A second set of items, of the plurality of items, may be determined, wherein the second set of items is targeted to a user. The second set of items includes the first item. Based upon the set of items and the second set of items, a set of candidate content items may be determined for inclusion in an auction associated with selection of content for presentation via a client device associated with the user. The set of candidate content items includes one or more content items associated with the set of items related to the first item. A content item may be selected from content items comprising the first set of candidate content items.

### BACKGROUND

Many services, such as websites, applications, etc. may provide platforms for viewing media. For example, a user may interact with a service. While interacting with the service, selected media may be presented to the user automatically. Some of the media may be advertisements advertising products and/or services associated with a company.

### SUMMARY

In accordance with the present disclosure, one or more computing devices and/or methods are provided. In an example, a first item, of a plurality of items associated with an entity, may be identified, wherein the first item is out of stock. A first set of items related to the first item may be determined based upon first item information associated with the first item. A second set of items, of the plurality of items, may be determined, wherein the second set of items is targeted to a user. The second set of items comprises the first item that is out of stock. Based upon the first set of items and the second set of items, a first set of candidate content items may be determined for inclusion in an auction associated with selection of content for presentation via a client device associated with the user. Each candidate content item of the first set of candidate content items is associated with an item of the plurality of items. The first set of candidate content items comprises one or more content items associated with the first set of items related to the first item. A first content item may be selected from content items comprising the first set of candidate content items via the auction. The first content item may be presented via the client device.

In an example, a first item, of a plurality of items associated with an entity, may be identified. An item name associated with the first item may be generated based upon first item information associated with the first item. A first set of items associated with the item name may be selected from the plurality of items associated with the entity. A plurality of sets of item information associated with the first set of items may be determined. A set of item information of the plurality of sets of item information is associated with an item of the first set of items. A second set of items related to the first item may be selected from the first set of items based upon the first item information and the plurality of sets of item information. A third set of items, of the plurality of items, may be determined, wherein the third set of items are targeted to a user. The third set of items comprises the first item. Based upon the second set of items and the third set of items, a first set of candidate content items may be determined for inclusion in an auction associated with selection of content for presentation via a client device associated with the user. Each candidate content item of the first set of candidate content items is associated with an item of the plurality of items. The first set of candidate content items comprises one or more content items associated with the second set of items related to the first item. A first content item may be selected from content items comprising the first set of candidate content items via the auction. The first content item may be presented via the client device.

In an example, a first item, of a plurality of items, may be identified, wherein the first item is out of stock. A first set of items related to the first item may be determined based upon first item information associated with the first item. A second set of items, of the plurality of items, may be determined, wherein the second set of items is targeted to a user. The second set of items comprises the first item that is out of stock. Based upon the first set of items and the second set of items, a first set of candidate content items may be determined for inclusion in an auction associated with selection of content for presentation via a client device associated with the user. Each candidate content item of the first set of candidate content items is associated with an item of the plurality of items. The first set of candidate content items comprises one or more content items associated with the first set of items related to the first item. A first content item may be selected from content items comprising the first set of candidate content items via the auction. The first content item may be presented via the client device.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for selecting content for presentation via devices.

FIG. 5A is a component block diagram illustrating an example system for selecting content for presentation via devices, where a first set of items related to a first item are determined using a related items determiner.

FIG. 5B is a component block diagram illustrating an example system for selecting content for presentation via devices, where a first item name is determined using an item name determiner.

FIG. 5C is a component block diagram illustrating an example system for selecting content for presentation via devices, where a second set of items is selected using a matching items determiner.

FIG. 5D is a component block diagram illustrating an example system for selecting content for presentation via devices, where a first set of items is selected from a second set of items using a top-k items determiner.

FIG. 5E is a component block diagram illustrating an example system for selecting content for presentation via devices, where a first client device transmits a first request for content to a server associated with a content system.

FIG. 5F is a component block diagram illustrating an example system for selecting content for presentation via devices, where a set of related content items is included in an auction.

FIG. 5G is a component block diagram illustrating an example system for selecting content for presentation via devices, where a second content item is presented via a second internet resource on a first client device.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

1.1. Networking

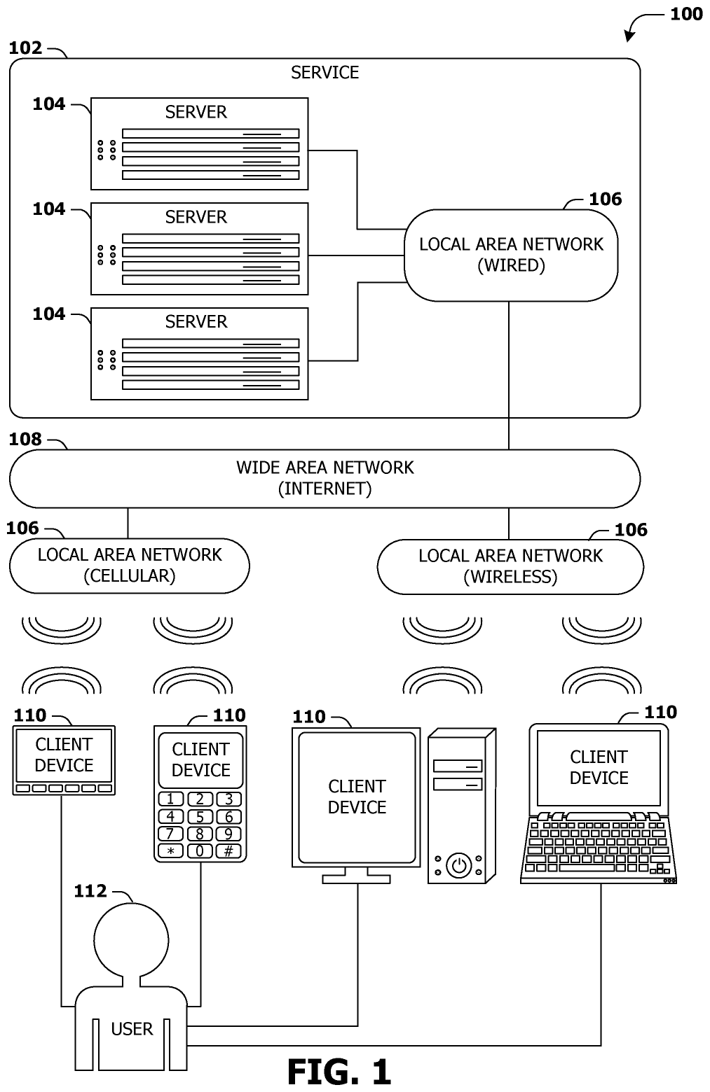

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

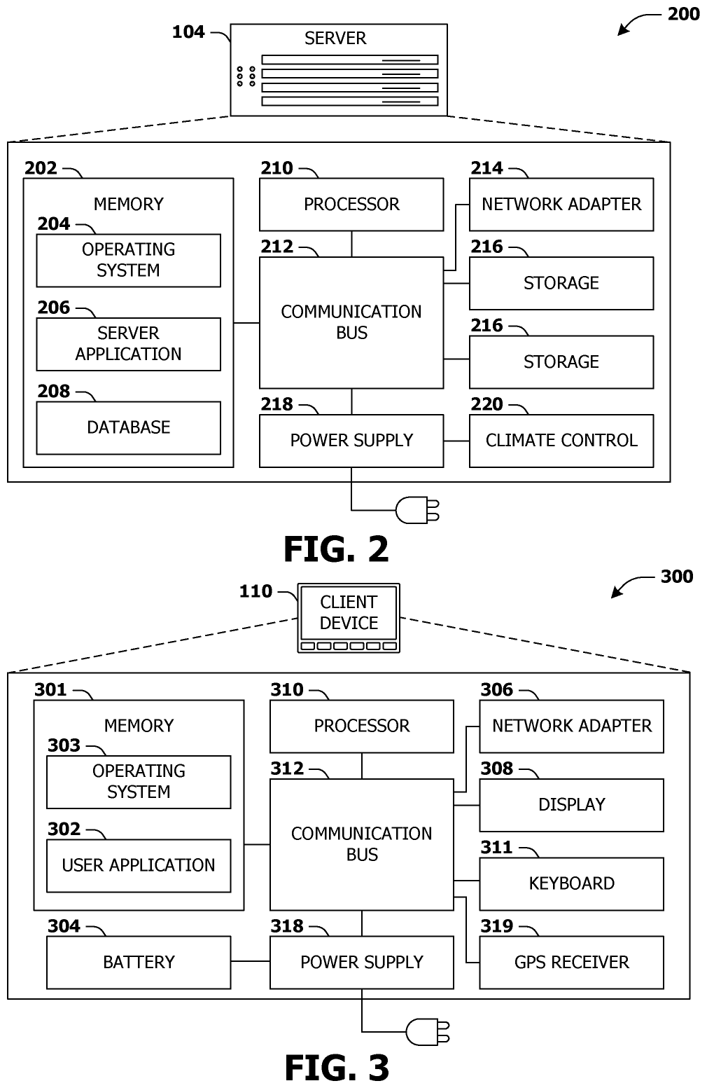

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for selecting content for presentation via devices are provided. For example, a first user (and/or a first client device associated with the first user) may access and/or interact with a service, such as a browser, software, a website, an application, an operating system, etc. that provides a platform for viewing and/or downloading content from a server associated with a content system. In some examples, in response to receiving a request for content associated with the first client device, the content system may select a first content item (e.g., an advertisement, an image, a link, a video, etc.), from a plurality of candidate content items, for presentation via the first client device. In an example, the plurality of candidate content items may comprise first content items (e.g., advertisements, images, links, videos, etc.) associated with targeted items that are targeted to the first user.

The targeted items may comprise products and/or services that can be purchased by the first user. An item of the targeted items may be targeted to the first user based upon user activity of the first user, such as based upon at least one of a determination that the first user accessed an internet resource associated with the item (e.g., a shopping web page that presents information associated with the item and/or that comprises an interface for purchasing the item), a determination that the first user added to the item to a shopping cart, a determination that the user added to the item to a wish list, etc.

A content item of the first content items may comprise information associated with an item of the targeted items and/or a link to an internet resource associated with the item (e.g., a device may access the internet resource in response to a selection of the content item). For example, the internet resource may comprise information associated with the item (e.g., a picture of the item, specifications of the item, a price for purchasing the item, a description of the item, a title of the item, etc.) and/or an interface (e.g., one or more selectable inputs) for at least one of purchasing the item, saving the item to a wish list, adding the item to a shopping cart, etc.

The targeted items may comprise an out of stock item (e.g., an item that is not available for purchase). In an example, the out of stock item may be targeted to the first user due to the first user having previously accessed an internet resource associated with the item (at a time in which the item was in stock, for example), wherein the item may have become out of stock (after the first user accessed the internet resource, for example). If a content item associated with the out of stock item is included in an auction and the content item is presented via the first client device (such as where the content item wins the auction), in response to a selection of the content item (e.g., in response to the first user clicking on the content item), the first client device may be navigated to an internet resource, associated with the out of stock item, where the first user may not be able to make a purchase of the out of stock item (due to the out of stock item not being available for purchase, for example), thereby causing a negative user experience for the first user.

Some systems attempt to avoid the negative user experience of providing content items associated with out of stock items by not including content items associated with out of stock items in the plurality of candidate content items. For example, in these systems, the content items associated with out of stock items may not participate in the auction for selection of a content item to be presented via the first client device in response to the request for content. That is, in these systems, an amount of content items that participate in the auction is reduced which may result in a lower quality content item (e.g., a content item that has a lower probability of being of interest to the first user and/or a lower probability of being clicked by the first user) being selected via the auction for presentation via the first client device.

Thus, in accordance with one or more of the techniques presented herein, based upon a determination that an item of the targeted items is out of stock, a set of related items (determined to be related to the out of stock item) may be determined. The set of related items may be in stock. One or more content items associated with the set of related items may be included in the plurality of candidate content items (e.g., the one or more content items may participate in the auction) and/or a content item associated with the out of stock item may not be included in the plurality of candidate content items (e.g., the content item associated with the out of stock item may not participate in the auction). For example, the one or more content items associated with the set of related items may be included in the plurality of candidate content items without the content item associated with the out of stock of item (e.g., the set of related items may serve as a replacement for the out of stock item in the auction). Including the set of related items in the plurality of candidate content items results in having an increased amount of content items to select from, which may result in a higher quality content item (e.g., a content item that has a higher probability of being of interest to the first user and/or a higher probability of being clicked by the first user) being selected via the auction and/or may result in an increase in generalized revenue for presenting content items via client devices (as a result of selecting higher quality content items for presentation via client devices, for example). In this way, a determination that the out of stock item is targeted to the first user may be leveraged using one or more of the techniques herein to provide the first user with an improved user experience by way of supplementing the plurality of candidate content items with the set of related items that are determined to be related to the out of stock item. Alternatively and/or additionally, in a scenario in which a content item associated with an item of the set of related items is selected for presentation to the first user, a user experience of the first user may be improved by way of enabling the first user to consume content similar to the out of stock item that the first user previously expressed an interest in.

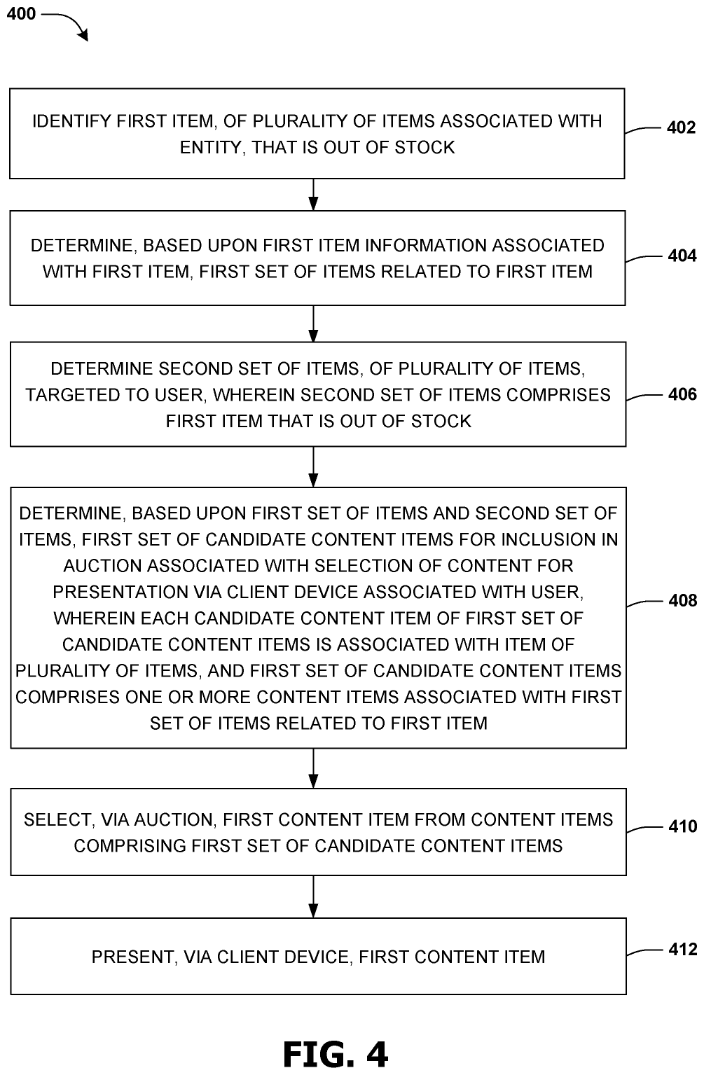

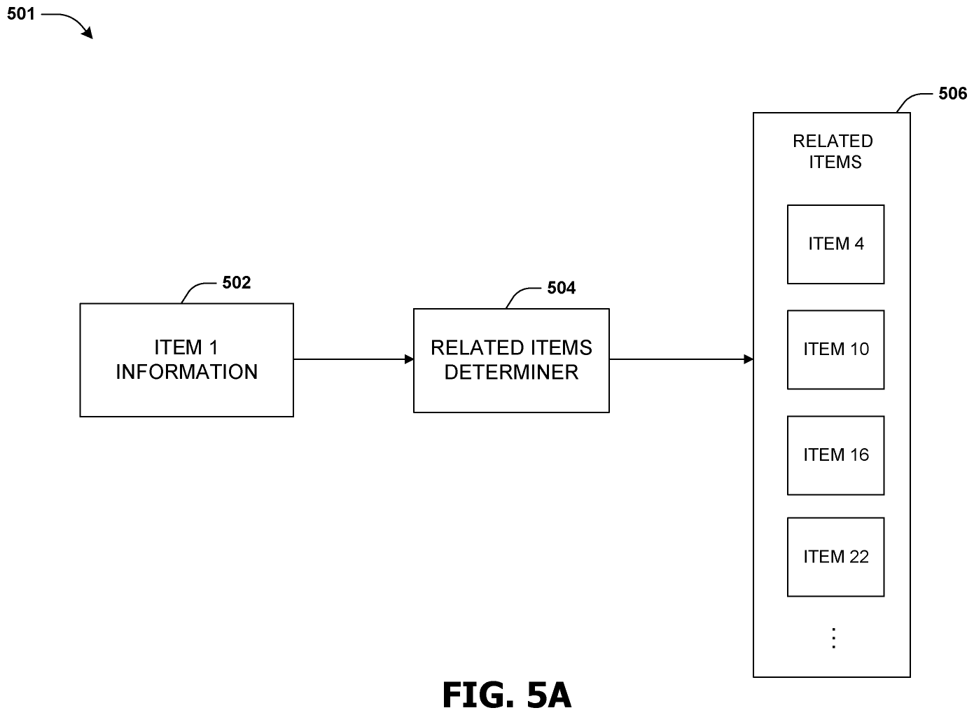

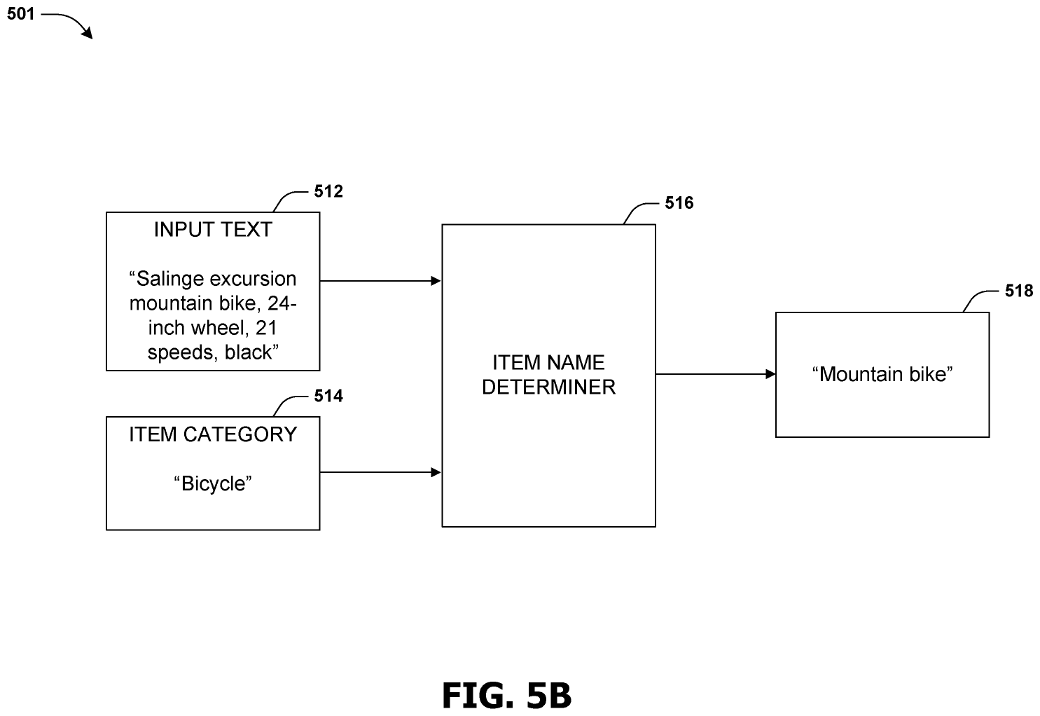

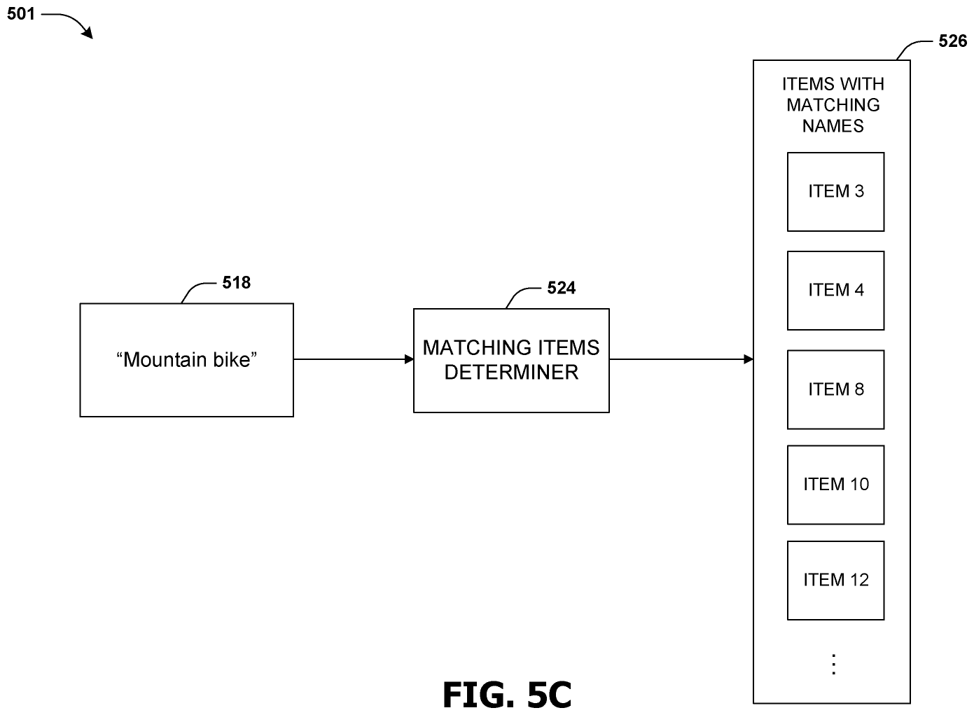

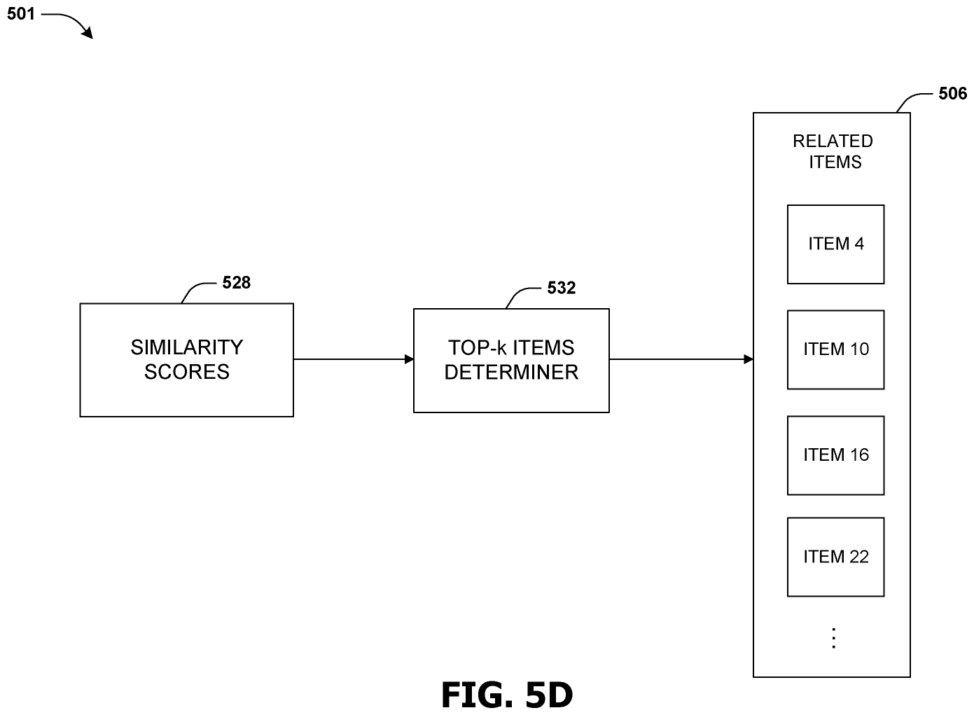

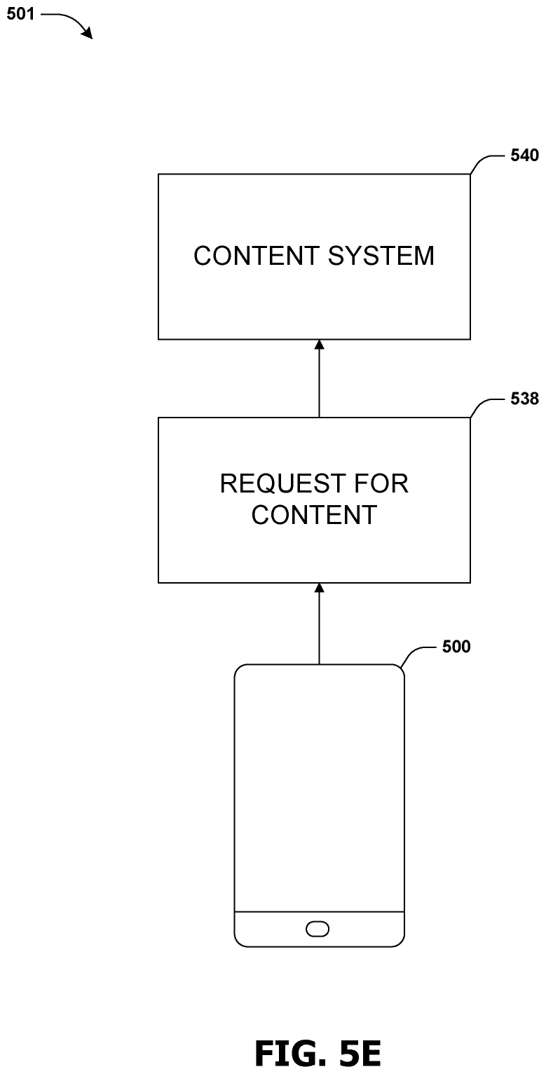

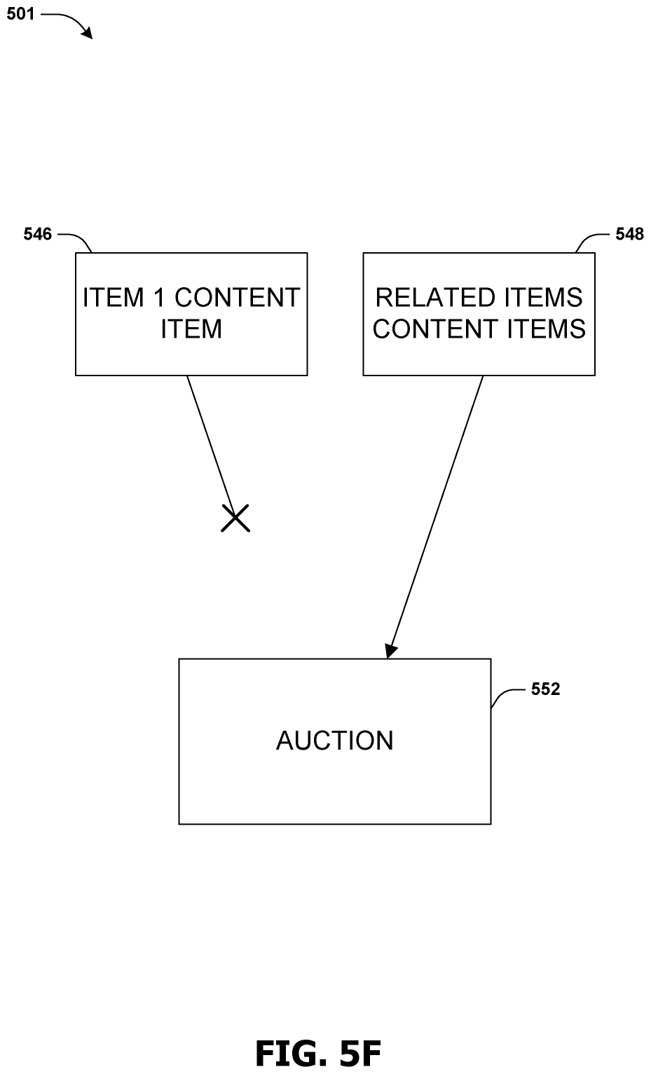

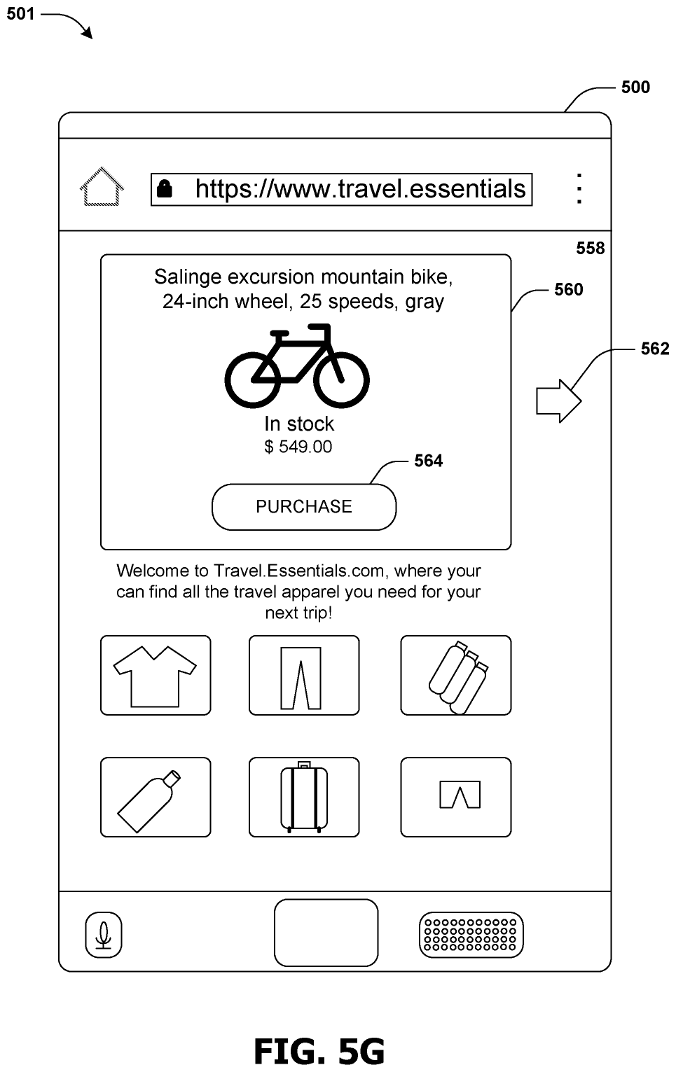

An embodiment of selecting content for presentation via devices is illustrated by an example method 400 of FIG. 4, and is further described in conjunction with system 501 of FIGS. 5A-5G. A content system for presenting content via client devices may be provided. In some examples, the content system may be an advertisement system (e.g., an online advertising system). Alternatively and/or additionally, the content system may not be an advertisement system. In some examples, the content system may provide content items to be presented via internet resources (e.g., at least one of web pages, websites, applications, etc.) associated with the content system. For example, the internet resources may be associated with websites (e.g., websites providing search engines, email services, news content, communication services, etc.) associated with the content system. The content system may provide content items to be presented in (dedicated) locations throughout the internet resources (e.g., one or more areas of the internet resources configured for presentation of content items). For example, a content item may be presented at the top of a web page associated with the content system (e.g., within a banner area), at the side of the web page (e.g., within a column), in a pop-up window, overlaying content of the web page, etc.

The content system may provide content items (e.g., advertisements, images, links, videos, etc.) associated with items (e.g., products, services, etc.) for presentation to users via client devices. For example, the content items may comprise advertisements that promote items and/or entities that provide (e.g., sell) the items.

At 402, a first item, of a first plurality of items associated with a first entity, may be identified. An item of the first plurality of items (and/or each item of the first plurality of items) may be at least one of a product, a service, etc. provided by (e.g., sold by) and/or advertised by the first entity. In an example, the first entity may be (and/or may be associated with) at least one of an advertiser (e.g., an advertiser that advertises items of the first plurality of items), a company (e.g., a company that sells items of the first plurality of items), a shopping website (e.g., a shopping website with which items of the first plurality of items can be purchased), a store (e.g., a store in which items of the first plurality of items can be purchased), an organization, etc. In an example, the first entity may be associated with a first set of internet resources (e.g., a set of one or more internet resources, such as at least one of one or more web pages, one or more websites, an application such as a mobile application, etc.). In an example, internet resources of the first set of internet resources may be web pages of a shopping website associated with the first entity. For example, an internet resource of the first set of internet resources may be associated with an item of the first plurality of items associated with the first entity, wherein the internet resource may comprise information associated with the item (e.g., a picture of the item, specifications of the item, a price for purchasing the item, a description of the item, a title of the item, etc.) and/or an interface (e.g., one or more selectable inputs) for at least one of purchasing the item, saving the item to a wish list, adding the item to a shopping cart, etc.

The first item is determined to be out of stock (e.g., the first entity does not have the first item available for sale and/or the first item may not be able to be purchased via the first set of internet resources associated with the first entity). In an example, the first item may be determined to be out of stock based upon an item inventory dataset (e.g., a product catalog) associated with the first entity. For example, the item inventory dataset may be indicative of items (e.g., the first plurality of items) associated with the first entity and/or item inventory information associated with the items (e.g., the item inventory information may be indicative of whether or not an item is in stock). In some examples, the item inventory dataset may be generated and/or updated based upon item updates (received from the first entity, for example) that are indicative of whether or not an item of the first plurality of items is in stock (e.g., available for sale via the first set of internet resources associated with the first entity).

At 404, a first set of items, of the first plurality of items, related to the first item may be determined based upon a first set of item information associated with the first item. The first set of items may be a first set of one or more items. In some examples, the first set of item information may be stored in an item information database. For example, the item information database may comprise a first plurality of sets of item information, associated with the first plurality of items, comprising the first set of item information associated with the first item. In some examples, a set of item information of the first plurality of sets of item information (and/or each set of item information of the first plurality of sets of item information) may comprise information associated with an item of the first plurality of items.

For example, a set of item information of the plurality of sets of item information (and/or each set of item information of the plurality of sets of item information) may be indicative of at least one of an item title of an item (e.g., text comprising a title of the item), an item description of the item (e.g., text comprising a description of the item, such as comprising one or more indications of one or more attributes of the item), an item category (e.g., a product taxonomy category, such as a product taxonomy category specific to at least one of a company, service, etc.) of the item, etc.

In an example, the first set of item information associated with the first item may comprise a first item title of the first item (e.g., “Salinge excursion mountain bike, 24-inch wheel, 21 speeds, black”), a first item description of the first item (e.g., “The new mountain bike by Salinge guarantees a smooth bike riding experience through the roughest of climates, with 24-inch wheels, 21 speeds and a matte black finish . . . ”), and/or a first item category of the first item. In an example, the first item category may comprise multiple hierarchies corresponding to multiple category levels associated with the first item (e.g., the first item category may comprise “Outdoor Recreation>Bicycles>Mountain Bikes”, where “Bicycles” is a sub-category of “Outdoor Recreation” and/or Mountain Bikes” is a sub-category of “Bicycles”). Alternatively and/or additionally, the first item category may comprise a single category level (e.g., the first item category may comprise “Outdoor Recreation”, “Bicycles”, “Mountain Bikes” or other category).

FIG. 5A illustrates the first set of items (shown with reference number 506) related to the first item being determined using a related items determiner 504. The first set of item information (shown with reference number 502) may be input to the related items determiner 504 and/or the related items determiner 504 may determine the first set of items 506 (related to the first item) based upon the first set of item information 502. In some examples, the related items determiner 504 determines the first set of items 506 using one or more of the techniques herein provided with respect to act 404 and/or FIGS. 5B-5D.

In some examples, a first item name (e.g., a core product name) associated with the first item may be generated based upon the first set of item information 502. In an example, the first item name may correspond to a name of the first item without characteristics-related attributes (e.g., characteristics-related attributes may comprise at least one of color, brand, size, model, etc.). In an example, the first item name may be generated based upon input text and/or the first item category. The input text may comprise the first item title and/or the first item description. In some examples, the input text comprises the first item title (without the first item description, for example). Alternatively and/or additionally, in an example in which the first item title is not available (e.g., the first set of item information 502 does not comprise the first item title), the input text may comprise the first item description. For example, the input text (based upon which the first item name is generated) may comprise the first item description only if the first item title is not available. Alternatively and/or additionally, the input text may comprise merely the first item description (even if the first item title is available). Alternatively and/or additionally, the input text may comprise both the first item title and the first item description.

In an example, the first item name may be generated based upon the first set of item information 502 (e.g., based upon the input text and/or the first item category) using an item name determination model, such as an annotation model (e.g., an item annotation model). The item name determination model may comprise a sequence to sequence (seq2seq) model (e.g., a sequence to sequence annotation model). In some examples, the item name determination model (e.g., the sequence to sequence model) may allow for determining the first item name to be a set of text that does not appear as a contiguous text span in the input text.

In an example, the item name determination model (e.g., the sequence to sequence model) comprises a language model (e.g., a pseudo-masked language model, such as a transformer-based pseudo-masked language model). In some examples, the language model comprises a bidirectional encoder and/or a sequence to sequence decoder. The language model may be trained (e.g., fine-tuned) using a training dataset (e.g., an editorial labeled training dataset). The first item name may be generated, using the item name determination model, in a sequence to sequence manner. It may be appreciated that generating the first item name in a sequence to sequence manner may enable the item name determination model to generate the first item name as a set of text that does not appear as a contiguous text span in the input text, thereby providing for an increased accuracy of the first item name (as compared with some systems that use sequence tagging approaches that can merely generate item names that contiguously and/or directly appear in input text). Further, as compared to item names determined using systems that are limited to generating item names that contiguously and/or directly appear in input text, the first item name (determined using the item name determination model that is not limited to generating the first item name as a contiguous set of text in the input text, for example) may provide for higher recall and/or higher precision in one or more retrieval acts that are performed, based upon the first item name, to identify items (e.g., a second set of items discussed below and/or the first set of items 506) associated with the first item. In an example in which the input text comprises “Club-Shaped 13 mm Sapphire Vintage Engagement Promise Ring”, the first item name may be determined to be “engagement ring” (even though “engagement ring” does not appear as a contiguous text span in the input text). The first item name being “engagement ring” may provide for higher recall and/or higher precision in the one or more retrieval acts than an item name determined using systems that are limited to generating the item name as a contiguous set of text in the input text. In an example, the systems that are limited to generating the item name as a contiguous set of text in the input text may determine the item name to be “ring” and/or “engagement promise ring”, wherein the first item name being “engagement ring” may provide for higher recall in the one or more retrieval acts than the item name “engagement promise ring” and/or may provide for higher precision in the one or more retrieval acts than the item name “ring”.

In some examples, the item name determination model is used to generate the first item name based upon the first item category. For example, the first item category may be used to disambiguate the input text, such as to identify a core item (e.g., a core product) of the first item and/or to generate the first item name to be representative of the core item. For example, the input text may be ambiguous, may not indicate a type of item of the first item and/or may be indicative of multiple core items (e.g., multiple item names). In an example, the input text (e.g., ambiguous input text) may comprise “Laptop AC Power Adapter Charger for Signal-one Computer Company Model 54623”. In the example, the input text may indicate multiple core items, such as at least one of “laptop”, “power adapter”, “laptop charger”, etc. In the example, the first item category may comprise “Electronics>Electronics Accessories>Power>Power Adapters and Chargers”. The first item category may be used (along with the input text, for example) to determine that the first item name (e.g., the core item of the first item) is “laptop charger”, whereas without the first item category (e.g., using merely the input text), the first item name may be determined to be names such as “laptop”, “power adapter”, etc. that are less accurate than “laptop charger”.

In some examples, data used to train the item name determination model may comprise text with masked tokens. The item name determination model may use first masks (e.g., conventional masks) to learn inter-relations between corrupted tokens and context via an autoencoding. The item name determination model may use second masks (e.g., pseudo masks) to learn intra-relations between masked spans via partially autoregressive modeling. Context encodings may be reused (to avoid redundant computation, for example) using position embeddings and/or self-attention masks. Alternatively and/or additionally, the first masks (e.g., conventional masks) used for the autoencoding may provide global masking information such that the position embeddings (e.g., all of the position embeddings) are accessible in autoregressive language modeling (e.g., partially autoregressive language modeling). In some examples, the autoencoding (e.g., an autoencoding task) trains a bidirectional encoder of the item name determination model and/or the autoregressive language modeling (e.g., autoregressive task) trains a sequence to sequence decoder of the item name determination model. In some examples, the item name determination model is a multi-layer (e.g., 12-layer or other number of layers) transformer with multiple attention heads (e.g., 12 or other number of attention heads). In some examples, the item name determination model is trained (e.g., pre-trained) using text from one or more sources, such as at least one of one or more databases, one or more internet resources, one or more news articles, one or more online encyclopedias, etc. In some examples, the item name determination model is trained (e.g., fine-tuned after pre-training the item name determination model using the text from the one or more sources) using labeled data. In some examples, the labeled data may be used to train the item name determination model for sequence to sequence item name generation (such as performed via the autoregressive language modeling). In some examples, the labeled data may comprise a plurality of sets of labeled data. A set of labeled data of the plurality of sets of labeled data may comprise an item title of an item, an item category of the item and/or an item name of the item (wherein the item name may be labeled by editors based on the item). Alternatively and/or additionally, the set of labeled data may comprise an item description of the item (such as in a scenario in which the item title of the item is not available). In an example, the item title and/or the item category (and/or the item description) may correspond to a source sequence and the item name may correspond to a target sequence. In an example, the set of labeled data may be concatenated as “[SOS] title [SEP] category [EOS] name [EOS]”, wherein [SOS] may correspond to start of sequence, [SEP] may correspond to a separator, [EOS] may correspond to end of sequence, “title” may correspond to the item title, “category” may correspond to the item category and/or “name” may correspond to the item name. In some examples, for the source sequence, dependencies between tokens are bidirectional (e.g., source tokens may attend to each other). The target sequence may be generated in an autogressive manner. A pseudo mask may be appended for each target token of one or more target tokens (of the target sequence, for example), wherein self-attention masks may be used for generation (e.g., autoregressive generation) of the target sequence. In some examples, an objective of training (e.g., fine-tuning) the item name determination model using the labeled data may be to maximize a likelihood that the item name determination model generates the target sequence given the source sequence (e.g., the source sequence may correspond to a text that is input to the item name determination model). In some examples, in response to [EOS] (after the item name, for example) being emitted, a generation process of the target sequence is terminated. In some examples, during decoding, beam search is used to generate target tokens (e.g., the target tokens may be individually generated).

FIG. 5B illustrates the first item name (shown with reference number 518) being determined using an item name determiner 516. The item name determiner 516 may comprise the item name determination model. The first item name 518 may be determined based upon the input text (shown with reference number 512) and/or the first item category (shown with reference number 514). For example, the input text 512 may comprise the first item title (e.g., “Salinge excursion mountain bike, 24-inch wheel, 21 speeds, black”) and the first item category 514 may comprise “bicycle”. The input text 512 and/or the first item category 514 may be analyzed by the item name determiner 516 to determine the first item name 518 (e.g., the first item name 518 may be a set of text comprising “Mountain bike”).

In some examples, a second set of items, associated with the first item name 518 may be selected from the first plurality of items associated with the first entity. The second set of items may be a set of one or more items. The first item name 518 may be compared with other item names associated with other items of the first plurality of items to select the second set of items. In some examples, an item may be selected from the first plurality of items for inclusion in the second set of items based upon a determination that an item name associated with the item matches the first item name 518 associated with the first item. For example, each item of the second set of items may be associated with an item name that matches the first item name 518. In some examples, an item name associated with an item may be determined to match the first item name 518 based upon a determination that the item name is the same as the first item name 518 (e.g., in a scenario in which the first item name 518 is “Mountain bike”, each item of the second set of items may be associated with an item name that is “Mountain bike”). Alternatively and/or additionally, an item name associated with an item may be determined to match the first item name 518 based upon a determination that the item name is similar to the first item name 518 (e.g., the item name associated with the item may be determined to match the first item name 518 based upon a determination that a similarity score associated with a similarity between the item name and the first item name 518 exceeds a threshold similarity score). In some examples, item names, associated with items of the first plurality of items other than the first item, may be determined using one or more of the techniques provided herein with respect to determining the first item name 518 associated with the first item.

In some examples, an item may be selected from the first plurality of items for inclusion in the second set of items based upon a determination that the item is in stock. For example, whether or not items of the first plurality of items are in stock may be determined using the item inventory dataset. In some examples, each item of the second set of items is determined to be associated with an item name that matches the first item name 518 and/or is determined to be in stock (e.g., the item inventory dataset is indicative of each item of the second set of items being available for sale via the first set of internet resources associated with the first entity).

FIG. 5C illustrates the second set of items (shown with reference number 526) being selected using a matching items determiner 524. The first item name 518 may be input to the matching items determiner 524 and/or the matching items determiner 524 may select the second set of items 526 based upon the first item name 518. In an example, the second set of items 526 may be selected from the first plurality of items based upon a determination that the second set of items 526 are associated with item names that match the first item name 518 and/or that the second set of items 526 are in stock (according to the item inventory dataset, for example).

In some examples, the first set of items 506 may be selected from the second set of items 526. A second plurality of sets of item information associated with the second set of items 526 may be determined. In some examples, the second plurality of sets of item information may comprise sets of item information, of the first plurality of sets of item information, associated with the second set of items 526. In an example, a set of item information of the second plurality of sets of item information (and/or each set of item information of the second plurality of sets of item information) is associated with an item of the second set of items 526 (e.g., the set of item information may comprise at least one of an item title of the item, an item description of the item, an item category of the item, etc.). In some examples, the first set of items 506 may be selected from the second set of items 526 based upon the first set of item information 502 (associated with the first item) and the second plurality of sets of item information (associated with the second set of items 526).

In some examples, a set of similarity scores (e.g., a set of one or more similarity scores) may be determined. In some examples, a similarity score of the set of similarity scores (and/or each similarity score of the set of similarity scores) may be associated with a similarity between the first item and an item of the second set of items 526. For example, the set of similarity scores may comprise a first similarity score associated with a first similarity between the first item and a second item of the second set of items 526, a second similarity score associated with a second similarity between the first item and a third item of the second set of items 526, etc.

In some examples, the set of similarity scores may be determined based upon the first set of item information 502 (associated with the first item) and the second plurality of sets of item information (associated with the second set of items 526). For example, the first set of item information 502 may be compared with a second set of item information (of the second plurality of sets of item information) associated with the second item to determine the first similarity score, the first set of item information 502 may be compared with a second set of item information (of the second plurality of sets of item information) associated with the second item to determine the second similarity score, etc.

In an example, the first similarity score may be determined based upon at least one of a measure (e.g., quantity) of words that are common to the first set of item information 502 (associated with the first item) and the second set of item information associated with the second item, a measure (e.g., quantity) of phrases that are common to the first set of item information 502 (associated with the first item) and the second set of item information (associated with the second item), etc.

Alternatively and/or additionally, the set of similarity scores may be determined based upon a first representation associated with the first item and a plurality of representations associated with the second set of items 526. In an example, the first representation may comprise an embedding based representation (e.g., an embedding) and/or a vector representation. The first representation may be generated based upon the first set of item information 502 (such as based upon at least one of the first item title of the first item, the first item description of the first item, the first item category 514 of the first item, etc.). In an example, the first representation may correspond to a representation (e.g., an embedding based representation and/or a vector representation) of a set of text comprising at least one of the first item title, the first item description, the first item category 514, etc. Alternatively and/or additionally, a representation of the plurality of representations (and/or each representation of the plurality of representations) may comprise an embedding based representation (e.g., an embedding) and/or a vector representation. A representation of the plurality of representations (and/or each representation of the second representations) may be generated based upon a set of item information of the second plurality of sets of item information (such as based upon at least one of an item title indicated by the set of item information, an item description indicated by the set of item information, an item category indicated by the set of item information, etc.). For example, the plurality of representations may comprise a second representation generated based upon the second set of item information associated with the second item, a third representation generated based upon a third set of item information (of the second plurality of sets of item information) associated with the third item, etc. In an example, the second representation may correspond to a representation (e.g., an embedding based representation and/or a vector representation) of a set of text comprising at least one of an item title of the second item, an item description of the second item, an item category of the second item, etc.

In some examples, the first representation and/or the plurality of representations may be generated using a natural language processing (NLP) model. In some examples, the NLP model comprises a language representation model, such as a Bidirectional Encoder Representations from Transformers (BERT) model (e.g., a Siamese distilled BERT model). In some examples, the BERT model is a Sentence-BERT model with one or more pooling operations at an output of the Sentence-BERT model (e.g., one or more Siamese networks may be formed via the one or more pooling operations). In an example, the NLP model may comprise a semantic retrieval model that trains (e.g., fine-tunes) the BERT model (e.g., a pre-trained distilled BERT model) through a Siamese network structure. In some examples, the BERT model is trained using a first dataset, such as a first dataset indicative of (and/or generated based upon) search queries by users using a search engine. Alternatively and/or additionally, the BERT model may be trained using a second dataset, such as a query-to-product relevance dataset (e.g., an editorial labeled query-to-product relevance dataset). The query-to-product relevance dataset may be indicative of levels of relevance of queries (e.g., a query may comprise a set of text, such as a set of text used to perform a search using a search engine) to items (e.g., products and/or services). For example, the BERT model may be trained using the first dataset and/or fine-tuned using the second dataset such that the BERT model is optimized for item retrieval (e.g., item retrieval may correspond to selection of the first set of items 506 from the second set of items 526). In some examples, the NLP model may generate representations (e.g., embeddings) to each have a fixed size (e.g., each representation generated by the NLP model may have the fixed size). For example, the first representation may be generated, using the NLP model, based upon text of the first set of item information 502, wherein the text may comprise at least one of the first item title, the first item description, the first item category 514, etc. (e.g., the text may comprise merely the first item title and/or may not comprise the first item description and/or the first item category 514). In some examples, the first representation is generated to have the fixed size. The plurality of representations associated with the second set of items 526 may be generated using one or more of the techniques provided herein with respect to generating the first representation.

A similarity score of the set of similarity scores (and/or each similarity score of the set of similarity scores) may be generated based upon the first representation associated with the first item and a representation, of the plurality of representations, associated with an item of the second set of items 526. In an example, one or more operations (e.g., mathematical operations) may be performed using the first representation and the second representation to determine the first similarity score (e.g., the first similarity score may be based upon (and/or may be equal to) a measure of similarity between the first representation and the second representation, such as a cosine similarity between the first representation and the second representation). In some examples, the first similarity score is generated using the NLP model. In some examples, other similarity scores of the set of similarity scores (other than the first similarity score) may be determined using one or more of the techniques provided herein with respect to determining the first similarity score.

The first set of items 506 may be selected from the second set of items 526 based upon the set of similarity scores. In some examples, the first set of items 506 may be selected from the second set of items 526 based upon a determination that the first set of items 506 are associated with highest similarity scores of the set of similarity scores. Alternatively and/or additionally, the first set of items 506 may be selected from the second set of items 526 based upon a determination that the first set of items 506 are associated with k highest similarity scores of the set of similarity scores (e.g., items associated with the k highest similarity scores of the set of similarity scores may be included in the first set of items 506). In an example where k is 10, 10 items associated with 10 highest similarity scores of the set of similarity scores may be selected and/or included in the first set of items 506. Alternatively and/or additionally, the second set of items 526 may be ranked based upon the set of similarity scores (e.g., an item having a higher similarity score of the set of similarity scores is ranked higher than an item having a lower similarity score of the set of similarity scores), and/or the top k ranked items may be selected from among the second set of items 526 (e.g., the top k ranked items may be included in the first set of items 506). Alternatively and/or additionally, the first set of items 506 may be selected from the second set of items 526 based upon a determination that the first set of items 506 are associated with similarity scores (of the set of similarity scores) that meet (e.g., are equal to or exceed) a first threshold similarity score (e.g., items that are associated with similarity scores, of the set of similarity scores, that do not meet the first threshold similarity score, may not be included in first set of items 506). In an example, the first threshold similarity score may be 0.8 (or other value).

It may be appreciated that using the Siamese network structure in association with the NLP model as provided herein may provide for the first representation and/or the plurality of representations to be generated more quickly and/or may provide for the first set of items 506 to be selected from the second set of items 526 more quickly. In some examples, generation of the first representation and/or the plurality of representations and/or selection of the first set of items 506 from the second set of items 526 may be performed using Locality Sensitive Hashing and/or Latent Semantic Hashing.

FIG. 5D illustrates the first set of items 506 being selected, from the second set of items 526, using a top-k items determiner 532. The set of similarity scores (shown with reference number 528) may be input to the top-k items determiner 532 and/or the top-k items determiner 532 may select the first set of items 506 (from the second set of items 526) based upon the set of similarity scores 528.

It may be appreciated that one or more of the techniques provided herein (e.g., determining the first item name 518, selecting the second set of items 526 based upon the first item name 518 and/or selecting the first set of items 506 based upon representations of the first item and the second set of items 526) may provide for more accurately selecting the first set of items 506. For example, by selecting the first set of items 506 using one or more of the techniques herein (e.g., determining the first item name 518, selecting the second set of items 526 based upon the first item name 518 and/or selecting the first set of items 506 based upon representations of the first item and the second set of items 526), the first set of items 506 may be more similar to the first item as compared to selecting the first set of items 506 using a system that does not use one or more of the techniques herein. The more accurate selection of the first set of items 506 (e.g., the first set of items 506 being more similar to the first item) may result in a higher likelihood that the first user has an interest in an item of the first set of items 506 (e.g., the item is a suitable replacement for the first item that is out of stock), and thus may provide for a higher likelihood that presentation of a content item selected via an auction in which the first set of items 506 participate results in a selection (e.g., a selection of the content item, such as an advertisement click) and/or a conversion (e.g., a purchase of an item advertised by the content item).

Alternatively and/or additionally, a similarity and/or relevance of the first set of items 506 to the first item may be increased as a result of determining the first item name 518, selecting the second set of items 526 based upon the first item name 518 and/or selecting the first set of items 506 based upon representations of the first item and the second set of items 526 (as compared to directly selecting the first set of items 506 from items of the first plurality of items without using the first item name 518 to determine the second set of items 526).

It may be appreciated that one or more of the techniques provided herein (e.g., determining the first item name 518, selecting the second set of items 526 based upon the first item name 518 and/or selecting the first set of items 506 based upon representations of the first item and the second set of items 526) may provide for a higher likelihood that at least one related item related to the first item is determined. For example, by using one or more of the techniques herein (e.g., determining the first item name 518, selecting the second set of items 526 based upon the first item name 518 and/or selecting the first set of items 506 based upon representations of the first item and the second set of items 526), a likelihood that the first set of items 506 (comprising at least one item related to the first item, for example) is determined (e.g., successfully determined) is increased as compared to attempting to determine related items using a system that does not use one or more of the techniques herein (e.g., one or more of the techniques herein increases a likelihood that at least one in stock item related to an out of stock item can be successfully determined).

Embodiments are contemplated in which the first item name 518 is not determined and/or the first set of items 506 is selected (e.g., directly selected) from items of the first plurality of items (without determining the second set of items 526, for example). For example, the first set of items 506 may be selected from items of the first plurality of items based upon representations (e.g., embeddings) of the first item and the items of the first plurality of items (such as using one or more of the techniques provided herein with respect to selecting the first set of items 506 from the second set of items 526).

At 406, a third set of items, of the first plurality of items, targeted to a first user may be determined. In some examples, the third set of items may comprise the first item (that is determined to be out of stock). The third set of items may be a set of one or more items.

In some examples, the third set of items (targeted to the first user) may be determined based upon user activity information associated with the first user. The user activity information may be indicative of user activity of the first user with one or more internet resources associated with the first entity, such as one or more internet resources of the first set of internet resources (e.g., web pages of the shopping website associated with the first entity). In an example, the user activity information may be indicative of a set of events associated with the first user and the first entity.

In some examples, the set of events comprises an event in which an internet resource of the first set of internet resources is accessed, wherein the internet resource is associated with an item of the first plurality of items. For example, the internet resource may comprise information associated with the item (e.g., a picture of the item, specifications of the item, a price for purchasing the item, a description of the item, a title of the item, etc.) and/or an interface (e.g., one or more selectable inputs) for at least one of purchasing the item, saving the item to a wish list, adding the item to a shopping cart, etc. In some examples, the item may be included in the third set of items targeted to the first user based upon the first user being associated with the event in which the internet resource is accessed. For example, the first user having accessed the internet resource associated with the item may be an indication that the first user has an interest in the item, wherein the item may be targeted to the first user (e.g., the item may be included in the third set of items) based upon determining that the first user has an interest in the item.

In some examples, the set of events comprises an event in which an item of the first plurality of items is added to a shopping cart associated with the first user and/or the first entity (e.g., the shopping cart may be a part of the shopping website associated with the first entity). For example, the shopping cart may comprise a list of one or more items selected by the first user (via the shopping website, for example). The shopping cart may provide an interface to review the one or more items selected by the first user, modify the one or more items in the shopping cart (e.g., add or remove items in the shopping cart) and/or purchase the one or more items in the shopping cart (e.g., the one or more items in the shopping cart may be purchased via a checkout function and/or payment function). For example, the item may be added to the shopping cart via an internet resource, of the first set of internet resources, associated with the item (e.g., the item may be added to the shopping cart via a selection of a selectable input, in the internet resource, associated with adding the item to the shopping cart). In some examples, the item may be included in the third set of items targeted to the first user based upon the first user being associated with the event in which the item is added to the shopping cart. For example, the first user having added the item to the shopping cart may be an indication that the first user has an interest in the item, wherein the item may be targeted to the first user (e.g., the item may be included in the third set of items) based upon determining that the first user has an interest in the item.

In some examples, the set of events comprises an event in which an item of the first plurality of items is added to a wish list associated with the first user and/or the first entity (e.g., the wish list may be a part of the shopping website associated with the first entity). For example, the wish list may comprise a list of one or more items selected by the first user (via the shopping website, for example). The wish list may provide an interface to review the one or more items selected by the first user, modify the one or more items in the wish list (e.g., add or remove items in the wish list) and/or move an item from the wish list to the shopping cart. In some examples, the item may be included in the third set of items targeted to the first user based upon the first user being associated with the event in which the item is added to the wish list. For example, the first user having added the item to the wish list may be an indication that the first user has an interest in the item, wherein the item may be targeted to the first user (e.g., the item may be included in the third set of items) based upon determining that the first user has an interest in the item.

In an example, the first item may be included in the third set of items based upon a determination (based upon the user activity information, for example) that the first user is associated with an event in which a first internet resource (of the first set of internet resources associated with the first entity, for example) associated with the first item is accessed. For example, a first client device (e.g., a phone, a laptop, a computer, a wearable device, a smart device, a television, any other type of computing device, hardware and/or software) is used to access the first internet resource associated with the first item, wherein the first client device may be associated with (e.g., may belong to and/or may be used by) the first user. Alternatively and/or additionally, the first item may be included in the third set of items based upon a determination (based upon the user activity information, for example) that the first user is associated with an event in which the first item is added to the shopping cart (e.g., a selection of a selectable input associated with adding the first item to the shopping cart associated with the first entity is received from the first client device associated with the first user). Alternatively and/or additionally, the first item may be included in the third set of items based upon a determination (based upon the user activity information, for example) that the first user is associated with an event in which the first item is added to the wish list (e.g., a selection of a selectable input associated with adding the first item to the wish list associated with the first entity is received from the first client device associated with the first user).

In some examples, the user activity information is determined based upon data received from one or more devices associated with the first entity, such as one or more servers that host the first set of internet resources associated with the first entity (e.g., one or more servers that host the shopping website associated with the first entity). In an example, the data may comprise pixel data determined using a tracking pixel that tracks user activity of the first user and/or the first client device on the first set of internet resources. For example, the data (e.g., the pixel data) may be indicative of one or more internet resources (of the first set of internet resources associated with the first entity, for example) that are accessed by the first user and/or the first client device, one or more items (of the first plurality of items, for example) that are added to the shopping cart, and/or one or more items (of the first plurality of items, for example) that are added to the wish list. In some examples, the data (e.g., the pixel data) may indicate that first user activity (e.g., user activity of the first user and/or the first client device on the first set of internet resources) is associated with a user identifier. The user activity information may be determined using the first user activity indicated by the data based upon the indication that the first user activity is associated with the user identifier (and/or based upon a determination that the user identifier is associated with the first user and/or the first client device).

At 408, a first set of candidate content items (e.g., a set of one or more candidate content items) may be determined based upon the first set of items 506 and the third set of items. For example, the first set of candidate content items may be determined (e.g., selected) for inclusion in content items from which a content item is to be selected for presentation via the first client device associated with the first user. For example, the first set of candidate content items may be determined for inclusion in a first auction associated with selection of content for presentation via the first client device. In some examples, the first set of candidate content items may be determined and/or a content item may be selected for presentation via the first client device (via the first auction, for example) in response to receiving a first request for content associated with the first client device and/or the first user.

For example, the first auction may be performed in response to receiving the first request for content. In some examples, the first auction may be performed by an auction module to select content for presentation via the first client device. The auction module may comprise (and/or may be part of) at least one of a supply-side platform (SSP), a content exchange (e.g., an ad exchange), etc. The first auction may comprise selection of a content item for presentation via the first client device in response to the first request for content. In an example, the first auction may be an advertising auction associated with selecting an advertisement. Alternatively and/or additionally, the first auction may not be an advertising auction and/or may comprise selecting a content item other than an advertisement based upon one or more criteria. The first request for content may correspond to a request to be provided with one or more content items (e.g., advertisements, images, links, videos, etc.) for presentation via a second internet resource, such as in one or more serving areas of the second internet resource (e.g., the first request for content may correspond to a request to provide one or more content items to be presented via the second internet resource while the second internet resource is accessed by the first client device). The second internet resource corresponds to at least one of a web page of a website associated with the content system, an application associated with the content system, an internet game associated with the content system, etc. (e.g., the content system may provide advertisements to be presented via the second internet resource on client devices).

FIG. 5E illustrates the first client device (shown with reference number 500) transmitting the first request for content (shown with reference number 538) to a server 540 associated with the content system. In some examples, the first request for content 538 may be transmitted (to the server 540) by the first client device 500 in response to accessing the second internet resource. Alternatively and/or additionally, the first request for content 538 may be transmitted (to the server 540) by the first client device 500 in response to the first client device 500 receiving first resource information associated with the second internet resource (e.g., a second server associated with the second internet resource may transmit the first resource information to the first client device 500 in response to receiving, from the first client device 500, a request to access the resource). Alternatively and/or additionally, the first request for content 538 may be transmitted by the second server associated with the second internet resource in response to the second server receiving, from the first client device 500, the request to access the second internet resource.

In some examples, a candidate content item of the first set of candidate content items (and/or each candidate content item of the first set of candidate content items) may be associated with an item of the first plurality of items. In some examples, content items associated with items of the third set of items (targeted to the first user) are included in the first set of candidate content items based upon a determination that the items are in stock (e.g., available for sale via the first set of internet resources associated with the first entity). Accordingly, a content item that is associated with an item, of the third set of items, that is in stock may be included in the first set of candidate content items.

In some examples, a content item associated with an item of the third set of items is not included in the first set of candidate content items if it is determined that the item is not in stock (e.g., the item is not available for sale via the first set of internet resources associated with the first entity). In some examples, if it is determined that an item of the third set of items is not in stock (such as the first item), content items associated with a set of items (e.g., a set of one or more items) related to the item may be included in the first set of candidate content items. For example, based upon the determination that the first item is included in the third set of items (targeted to the first user) and the determination the first item is not in stock (e.g., the first item is not available for sale via the first set of internet resources associated with the first entity), content items associated with the first set of items 506 (determined to be related to the first item) are included in the first set of candidate content items.

An example is shown in FIG. 5F. In the example, a first content item 546 associated with the first item may not be included in the first auction (shown with reference number 552) and/or a set of related content items 548 (e.g., a set of one or more related content items) may be included in the first auction 552. For example, the first content item 546 may not be included in the first auction 552 based upon the determination that the first item is not in stock. The set of related content items 548 may comprise content items associated with items of the first set of items 506 (determined to be related to the first item). The set of related content items 548 may be included in the first auction 552 based upon a determination that the first item is not in stock, a determination that the first item is targeted to the first user (e.g., the first item is included in the third set of items), and/or a determination that the set of related content items 548 are associated with the first set of items 506 related to the first item (that is targeted to the first user). Alternatively and/or additionally, the set of related content items 548 may be included in the first auction 552 based upon a determination that items (e.g., the first set of items 506) associated with the set of related content items 548 are in stock (e.g., the items are available for sale via the first set of internet resources associated with the first entity).

At 410, a second content item may be selected from a plurality of content items comprising the first set of candidate content items. For example, the second content item may be selected from the plurality of content items via the first auction 552. For example, the second content item may be selected from the plurality of content items for presentation via the first client device 500. In some examples, the plurality of content items comprises one or more content items other than the first set of candidate content items.

In some examples, the second content item may be selected from the plurality of content items based upon a plurality of content item scores associated with the plurality of content items. In an example, the plurality of content item scores may comprise a first content item score associated with the second content item. The second content item may be selected from among the plurality of content items for presentation via the first client device 500 based upon a determination that the first content item score exceeds a threshold content item score. Alternatively and/or additionally, the second content item may be selected from among the plurality of content items for presentation via the first client device 500 based upon a determination that the first content item score is higher than other content item scores of the plurality of content item scores. Alternatively and/or additionally, the second content item may be selected from among the plurality of content items for presentation via the first client device 500 based upon a determination that the first content item score is a highest content item score among the plurality of content item scores.

In some examples, the plurality of content item scores may be determined based upon a plurality of positive signal probabilities associated with the plurality of content items. The plurality of positive signal probabilities may comprise a first positive signal probability associated with the second content item. The first positive signal probability may correspond to a probability of receiving a positive signal associated with the second content item in response to presenting the second content item via the second internet resource on the first client device 500. In an example, the positive signal may correspond to an indication of a selection of the second content item (e.g., the first positive signal probability may be a click probability). Alternatively and/or additionally, the positive signal may correspond to an indication of a conversion event associated with the second content item (e.g., the first positive signal probability may be a conversion probability). The conversion event may correspond to a purchase of a fourth item (e.g., a product and/or a service) associated with the second content item (e.g., the second content item may advertise and/or promote the fourth item and/or the second content item may comprise information associated with the fourth item). Alternatively and/or additionally, the positive signal may correspond to an indication of one or more interactions with the second content item (e.g., the first positive signal probability may be a probability that the first user interacts with the second content item in response to presentation of the second content item via the second internet resource on the first client device 500). Alternatively and/or additionally, the positive signal may correspond to an indication the second content item being presented for longer than a threshold duration of time (e.g., the first positive signal probability may be a probability that the second content item is presented for longer than the threshold duration of time in response to presentation of the second content item via the second internet resource on the first client device 500).

In some examples, the first positive signal probability may be determined based upon historical information associated with the second content item. In an example, the historical information may be indicative of a first positive signal rate (e.g., at least one of a click rate, a conversion rate, etc.) associated with the second content item. The first positive signal rate may be indicative of a relationship between (e.g., one or more of a proportion, a ratio, a percentage, etc.) a quantity of instances that the second content item is presented via client devices and a quantity of instances that positive signals (e.g., indications of at least one of selections, conversion events, etc.) associated with the second content item are received (responsive to presenting the second content item). The first positive signal probability may be determined based upon the first positive signal rate (e.g., a higher positive signal rate associated with the second content item may correspond to a higher positive signal probability associated with the second content item).

Alternatively and/or additionally, the first positive signal probability may be determined based upon whether or not the second content item is associated with an item that is targeted to the first user. For example, based upon a determination that the fourth item associated with the second content item is targeted to the first user (e.g., the third set of items comprises the fourth item), the first positive signal probability may be increased (e.g., the first positive signal probability may be higher if the fourth item is targeted to the first user than if the fourth item is not targeted to the first user).

In some examples, the plurality of content item scores may be determined based upon a plurality of bid values associated with the plurality of content items. The plurality of bid values may comprise a first bid value associated with the second content item. The first bid value may be determined based upon a budget (e.g., a daily budget) and/or a target spend pattern associated with the second content item. Alternatively and/or additionally, the first bid value and/or the budget may be received from a device associated with one or more entities (e.g., an advertiser, a company, a brand, an organization, etc.) associated with the second content item. One or more operations (e.g., mathematical operations) may be performed to determine the first content item score based upon the first positive signal probability and/or the first bid value. In an example, the first content item score may be equal to a product of the first positive signal probability and the first bid value. Other content item scores (e.g., content item scores, of the plurality of content item scores, other than the first content item score) associated with other content items (e.g., other content items, of the plurality of content items, other than the second content item) may be determined using one or more of the techniques provided herein with respect to determining the first content item score.

At 412, the second content item is presented via the first client device 500 associated with the first user. The second content item may be presented in response to selecting the second content item (via the first auction 552, for example). For example, the content system may transmit the second content item to the first client device 500 (for presentation via the second internet resource on the first client device 500) in response to selecting the second content item via the first auction 552.

FIG. 5G illustrates the second content item (shown with reference number 560) being presented via the second internet resource (shown with reference number 558) on the first client device 500. In the example shown in FIG. 5G, the fourth item (associated with the second content item 560) may be an item of the first set of items 506 that are determined to be related to the first item and/or are associated with the first entity. In the example shown in FIG. 5G, the fourth item has similar attributes as the first item (e.g., the fourth item and the first item are both Salinge excursion mountain bikes with 24-inch wheels, where a difference between the fourth item and the first item is a number of speeds and color, such as where the first item is 21 speeds and is in black, whereas the fourth item is 25 speeds and is in grey). Alternatively and/or additionally, an item of the first set of items 506 may be the same as the first item, such as where there is no difference between one or more attributes of the first item (e.g., out of stock item) and one or more attributes of the item (e.g., in stock item). The second content item 560 may be an advertisement of the fourth item and/or may comprise information associated with the fourth item (e.g., an image of the fourth item, a description of the fourth item, an indication that the fourth item is in stock and/or a price of the fourth item).

The second content item 560 may comprise a link to a third internet resource. The third internet resource may comprise information associated with the fourth item (e.g., a picture of the fourth item, specifications of the fourth item, a price for purchasing the fourth item, a description of the fourth item, a title of the fourth item, etc.) and/or an interface (e.g., one or more selectable inputs) for at least one of purchasing the fourth item, saving the fourth item to a wish list, adding the fourth item to a shopping cart, etc. For example, the second content item 560 may comprise a selectable input 564 associated with accessing the third internet resource. In response to a selection of the selectable input 564, the first client device 500 may access and/or display the third internet resource (associated with the link, for example).

In the example shown in FIG. 5G (where the fourth item is an item of the first set of items 506 determined to be related to the first item and/or are associated with the first entity), the third internet resource may be an internet resource, associated with the first entity, that can be used for purchasing the fourth item from the first entity. For example, the third internet resource may be an internet resource of the first set of internet resources (e.g., the shopping website associated with the first entity).

In some examples (such as where the fourth item associated with the second content item 560 is an item of the first set of items 506 determined to be related to the first item), the second content item 560 may comprise an indication that the second content item 560 is being displayed based upon a determination that the first user is interested in the first item (and/or that the first item is targeted to the first user) and/or an indication that the fourth item associated with the second content item 560 is related to the first item. For example, the second content item 560 may comprise “This item is shown based upon your interest in Salinge excursion mountain bike, 24-inch wheel, 21 speeds, black”.

In some examples, multiple content items (comprising the second content item 560) may be selected (via the first auction 552, for example) for presentation via the first client device 500 in response to the first request for content 538. For example, the multiple content items may be selected from the plurality of content items based upon a determination that the multiple content items are associated with highest content item scores of the plurality of content item scores. Alternatively and/or additionally, the multiple content items may be selected from the plurality of content items based upon a determination that the multiple content items are associated with n highest content item scores of the plurality of content item scores (e.g., content items associated with the n highest content item scores of the plurality of content item scores may be included in the multiple content items). In an example where n is 3, 3 content items associated with 3 highest content item scores of the plurality of content item scores may be selected and/or included in the multiple content items. Alternatively and/or additionally, the plurality of content items may be ranked based upon the plurality of content item scores (e.g., a content item having a higher content item score of the plurality of content item scores is ranked higher than a content item having a lower content item score of the plurality of content item scores), and/or the top n ranked content items may be selected from among the plurality of content items (e.g., the top n ranked content items may be included in the multiple content items). Alternatively and/or additionally, the multiple content items may be selected from the plurality of content items based upon a determination that the multiple content items are associated with content item scores (of the plurality of content item scores) that meet (e.g., are equal to or exceed) a first threshold content item score (e.g., content items that are associated with content item scores, of the plurality of content item scores, that do not meet the first threshold content item score, may not be included in the multiple content items).

Alternatively and/or additionally, the multiple content items may be selected from the set of related content items 548 (comprising content items associated with the first set of items 506 that are determined to be related to the first item). For example, each content item of the multiple content items may be associated with (e.g., may advertise) an item, of the first set of items 506, that is determined to be related to the first item. In some examples, the multiple content items may be selected from the set of related content items 548 in response to selecting a content item of the set of related content items 548 (via the first auction 552, for example). For example, if a content item of the set of related content items 548 is selected (via the first auction 552, for example) from the plurality of content items for presentation via the first client device 500, one or more other content items, of the set of related content items 548, may be included in the multiple content items to be presented via the first client device 500. In an example, the multiple content items may be selected from the set of related content items 548 based upon a determination that a content item score associated with a content item of the set of related content items 548 is a highest content item score of the plurality of content item scores.

In an example in which the multiple content items are selected from the first set of related content items 548 (e.g., where each content item of the multiple content items is associated with an item, of the first set of items 506, that is determined to be related to the first item), the multiple content items may be selected from the first set of related content items 548 based upon a second set of similarity scores, of the set of similarity scores 528, associated with the first set of related content items 548. The second set of similarity scores may be a set of one or more similarity scores. For example, the second set of similarity scores may comprise similarity scores, of the set of similarity scores 528, that are associated with items of the first set of items 506 (determined to be related to the first item). In an example in which the second content item 560 is associated with the fourth item of the first set of items 506 (determined to be related to the first item), the second set of similarity scores may comprise at least one of a third similarity score associated with the second content item 560 of the first set of related content items 548 (e.g., the third similarity score is associated with a similarity between the first item and the fourth item), a fourth similarity score associated with a third content item of the first set of related content items 548 (e.g., the fourth similarity score is associated with a similarity between the first item and a fifth item, wherein the third content item may be an advertisement of the fifth item and/or may comprise information associated with the fifth item), etc. For example, the multiple content items may be selected based upon a determination that the multiple content items are associated with highest similarity scores of the second set of similarity scores. Alternatively and/or additionally, the multiple content items may be selected from the first set of related content items 548 based upon a determination that the multiple content items are associated with m highest similarity scores of the second set of similarity scores (e.g., content items associated with the m highest similarity scores of the second set of similarity scores may be included in the multiple content items). In an example where m is 3, 3 content items associated with 3 highest similarity scores of the second set of similarity scores may be selected and/or included in the multiple content items. Alternatively and/or additionally, the first set of related content items 548 may be ranked based upon the second set of similarity scores (e.g., a content item having a higher similarity score of the second set of similarity scores is ranked higher than a content item having a lower similarity score of the second set of similarity scores), and/or the top m ranked content items may be selected from among the first set of related content items 548 (e.g., the top m ranked content items may be included in the multiple content items).

In some examples, an order of content items (e.g., an arrangement and/or succession of content items) with which the multiple content items are presented via the first client device 500 may be based upon rankings associated with the multiple content items. In an example in which the multiple content items are selected from the first set of related content items 548 (e.g., each content item of the multiple content items is associated with an item, of the first set of items 506, that is determined to be related to the first item), the rankings may be determined based upon similarity scores (of the second set of similarity scores) associated with the multiple content items (e.g., a content item associated with a higher similarity score is ranked higher than a content item associated with a lower similarity score). In an example, a content item associated with a higher ranking may be displayed at least one of above, before, more prominently, etc. than a content item associated with a lower ranking.

In some examples, the multiple content items may be presented via a carousel interface (e.g., an interface with carousel advertising format) that enables navigation between content items of the multiple content items. For example, the carousel interface may comprise a navigation selectable input 562 to provide for navigating from the second content item 560 to a next content item of the multiple content items (e.g., the next content item may be according to the order of content items). Alternatively and/or additionally, the carousel interface may navigate from the second content item 560 to the next content item in response to a swipe (e.g., a horizontal swipe) across the carousel interface (such as where a display of the first client device 500 corresponds to a touchscreen). Thus, an example in which the multiple content items are selected from the first set of related content items 548 (e.g., each content item of the multiple content items is associated with an item, of the first set of items 506, that is determined to be related to the first item), the first user may use the carousel interface to navigate through the multiple content items to view information associated with multiple items that are related to the first item. In some examples, content items of the multiple content items (e.g., presented via the carousel interface) may be at least one of semantically, visually, behaviorally, etc. similar to each other.

An order in which acts of the example method 400 are performed may be differ across various embodiments of the present disclosure.

In some embodiments, a data store comprising information associated with out of stock items and/or related items may be maintained. In some examples, a data store update process may be performed to update the data store. The data store update process may comprise a related item determination process. In the related item determination process, one or more items that are out of stock may be identified (e.g., it may be determined that the one or more items are out of stock). In an example, one or more items that are out of stock may be identified based upon the item inventory dataset (e.g., the product catalog) associated with the first entity and/or based upon one or more other item inventory datasets associated with one or more other entities. The one or more items may comprise the first item and/or one or more other items. In the related item determination process, one or more sets of related items associated with the one or more items may be determined (such as using one or more of the techniques provided herein with respect to determining the first set of items 506 related to the first item). The one or more sets of related items may comprise the first set of items 506 (determined to be related to the first item of the one or more items) and/or one or more other sets of related items (determined to be related to the one or more other items). The data store update process may comprise storing information determined via the related item determination process in the data store. The information may indicate that the one or more items are out of stock. The information may be indicative of the one or more sets of related items associated with the one or more items that are out of stock. For example, the information may indicate that the first item is out of stock and/or may indicate that the first set of items 506 (of the one or more sets of related items) is related to the first item (of the one or more items determined to be out of stock). In some examples, in response to receiving the first request for content 538, the data store may be analyzed based upon the third set of items (targeted to the first user) to identify one or more second items, of the third set of items, that are out of stock, and/or to identify one or more second sets of related items, of the one or more sets of related items, associated with the one or more second items. For example, the one or more second items (that are targeted to the first user and are determined to be out of stock) may comprise the first item, and the one or more second sets of related items may comprise the first set of items 506. Based upon determining that the one or more second items (that are targeted to the first user) are out of stock and/or that the one or more second sets of related items are related to the one or more second items, content items associated with items of the one or more second sets of related items may be included in the first set of candidate content items and/or the plurality of content items (from which one or more content items are selected via the first auction 552 for presentation via the first client device 500, for example). In some examples, based upon determining that the one or more second items (that are targeted to the first user) are out of stock, content items associated with the one or more second items (e.g., content items that advertise the one or more second items and/or that comprise information associated with the one or more second items) may not be included in the first set of candidate content items and/or the plurality of content items. In some examples, the data store update process may be performed multiple times (e.g., periodically, such as at least one of daily, weekly, etc.) to update the data store. The data store update process may be performed in response to receiving an item update (received from the first entity, for example) that is indicative of whether or not one or more items associated with the first entity are in stock (e.g., available for sale via the first set of internet resources associated with the first entity). For example, it may be determined, via performance of the related item determination process, that an item previously determined to be out of stock is currently in stock. Based upon the determination that the item is currently in stock, the data store may be updated such that the data store does not indicate that the item is out of stock. Alternatively and/or additionally, it may be determined, via performance of the related item determination process, that an item previously determined to be in stock is currently out of stock. Based upon the determination that the item is currently out of stock, the data store may be updated such that the data store indicates that the item is out of stock and/or such that the data store indicates a set of related items (e.g., a set of one or more related items) related to the item.

In some embodiments, whether or not the third set of items (targeted to the first user) comprise one or more out of stock items may be determined in response to receiving the first request for content 538. For example, in response to receiving the first request for content 538, one or more items, of the third set of items, that are out of stock may be identified based upon the item inventory dataset (e.g., the product catalog) associated with the first entity and/or based upon one or more other item inventory datasets associated with one or more other entities. The one or more items (that are out of stock and are targeted to the first user) may comprise the first item and/or one or more other items. In response to identifying the one or more items (that are out of stock and are targeted to the first user), one or more sets of related items associated with the one or more items may be determined (such as using one or more of the techniques provided herein with respect to determining the first set of items 506 related to the first item). The one or more sets of related items may comprise the first set of items 506 (determined to be related to the first item of the one or more items) and/or one or more other sets of related items (determined to be related to the one or more other items). For example, one or more acts provided herein with respect to act 404 of the example method 400 may be performed (e.g., in real time) in response to receiving the first request for content 538 and/or determining that the first item, which is included in the third set of items targeted to the first user, is out of stock. Based upon determining that the one or more items (that are targeted to the first user) are out of stock and/or that the one or more sets of related items are related to the one or more items, content items associated with items of the one or more sets of related items may be included in the first set of candidate content items and/or the plurality of content items (from which one or more content items are selected via the first auction 552 for presentation via the first client device 500, for example). In some examples, based upon determining that the one or more items (that are targeted to the first user) are out of stock, content items associated with the one or more items (e.g., content items that advertise the one or more items and/or that comprise information associated with the one or more items) may not be included in the first set of candidate content items and/or the plurality of content items.

It may be appreciated that, in some embodiments, rather than the first plurality of items merely comprising items that are associated with the first entity, the first plurality of items may be associated with multiple entities. In an example, one or more first items of the first plurality of items may be associated with the first entity (e.g., the one or more first items may be sold and/or advertised by the first entity), one or more second items of the first plurality of items may be associated with a second entity (e.g., the one or more second items may be sold and/or advertised by the second entity), etc.

It may be appreciated that, in some embodiments, one or more of the techniques provided herein may be used to determine a set of items (e.g., a set of one or more items) related to an in stock item (that is targeted to a user, for example) and/or to include content items associated with the set of items in an auction to supplement the auction with additional content items (e.g., thereby providing for an increased amount of content items to select from in the auction, which may result in a higher quality content item being selected in the auction). In an example, the first item may be determined to be in stock. The set of related content items 548 associated with the first set of items 506 (determined to be related to the first item) may be included in the first set of candidate content items and/or the plurality of content items (from which one or more content items are selected via the first auction 552 for presentation via the first client device 500, for example). In the example in which the first item is determined to be in stock, a content item associated with the first item (e.g., a content item that advertises the first item and/or comprises information associated with the first item) may also be included in the first set of candidate content items and/or the plurality of content items. For example, the set of related content items 548 associated with the first set of items 506 and the content item associated with the first item may participate in the first auction 552.

Although various examples of the present disclosure are described with respect to selection and/or presentation of content items comprising advertisements, embodiments are contemplated in which the content items comprise any type of content, such as at least one of search results, audio (e.g., songs, podcasts, etc.), video (e.g., movies, shows, video clips, etc.), articles, social media feeds, suggested content (e.g., links to videos, audio, articles, social media feeds, etc.), etc. while staying within the scope of the present disclosure.

Implementation of at least some of the disclosed subject matter may lead to benefits including, but not limited to, more accurate and/or appropriate selection of a content item for presentation via the first client device 500 that has a higher probability of resulting in the content item being selected and/or a higher probability of the first user consuming the content item to have an interest in the content item (e.g., as a result of determining the first set of items 506 related to the first item, as a result of including the set of related content items 548 associated with the first set of items 506 in the first auction 552, thereby providing for an increased amount of content items to select from in the first auction 552, which may result in a higher quality content item being selected in the first auction 552, etc.).

Alternatively and/or additionally, implementation of at least some of the disclosed subject matter may lead to benefits including a reduction in screen space and/or an improved usability of a display (e.g., of the first client device 500) (e.g., as a result of the higher probability of the first user consuming the content item to have an interest in the content item, wherein the first user may not view content that the first user does not have an interest in, wherein the first user may not need to open a separate application and/or a separate window in order to find content that the first user has an interest in, etc.).

Alternatively and/or additionally, implementation of at least some of the disclosed subject matter may lead to benefits including a reduction in screen space and/or an improved usability of a display (e.g., of the first client device 500) (e.g., as a result of determining the first set of items 506 related to the first item that is out of stock, as a result of displaying a content item, of the set of related content items 548, via the first client device 500, wherein the content item may comprise information associated with an in stock item related to the first item that is out of stock, wherein the first user may not need to open a separate application and/or a separate window in order to find the information associated with the in stock item that is related to the first item, etc.).

Alternatively and/or additionally, implementation of at least some of the disclosed subject matter may lead to benefits including an increase in generalized revenue for presenting content items via client devices (e.g., as a result of the higher probability of the content item being selected and/or the higher probability of the first user consuming the content item to have an interest in the content item, thereby increasing a probability that the first user performs a conversion event associated with the content item, such as purchases a product and/or service from an entity associated with the content item, etc.).

Alternatively and/or additionally, implementation of at least some of the disclosed subject matter may lead to benefits including a reduction in bandwidth (e.g., as a result of reducing a need for the first user to open a separate application and/or a separate window in order to search throughout the internet and/or navigate through internet content to find content that the first user has an interest in).

In some examples, at least some of the disclosed subject matter may be implemented on a client device, and in some examples, at least some of the disclosed subject matter may be implemented on a server (e.g., hosting a service accessible via a network, such as the Internet).

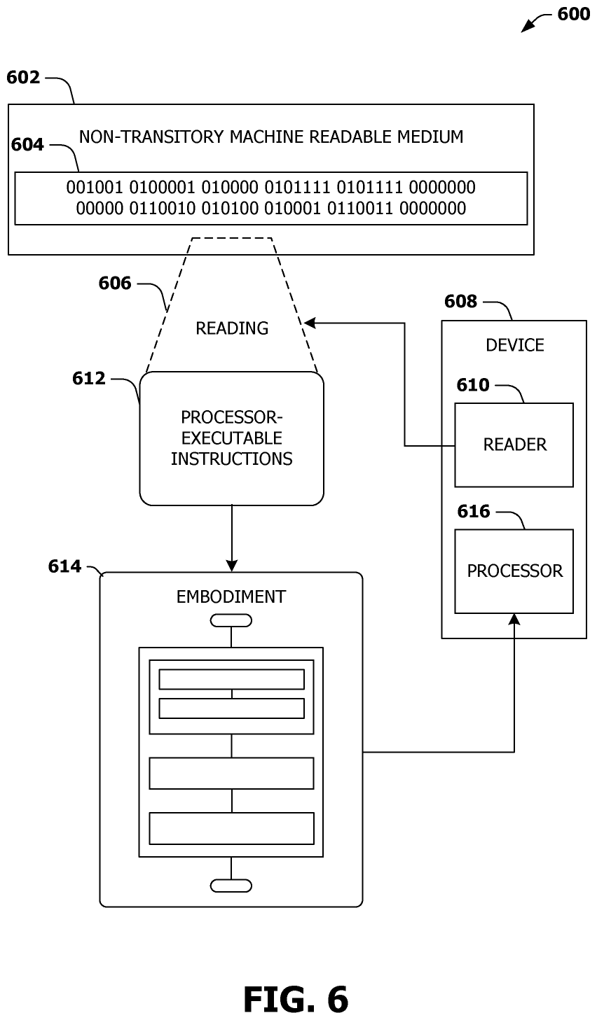

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIG. 4, for example. In some embodiments, the processor-executable instructions 612 are configured to cause implementation of a system, such as at least some of the example system 501 of FIGS. 5A-5G, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
identifying a first item, of a plurality of items associated with an entity, that is out of stock;
determining, based upon first item information associated with the first item, a first set of items related to the first item;
determining a second set of items, of the plurality of items, targeted to a user, wherein the second set of items comprises the first item that is out of stock;
determining, based upon the first set of items and the second set of items, a first set of candidate content items for inclusion in an auction associated with selection of content for presentation via a client device associated with the user, wherein:
each candidate content item of the first set of candidate content items is associated with an item of the plurality of items; and
the first set of candidate content items comprises one or more content items associated with the first set of items related to the first item;
selecting, via the auction, a first content item from content items comprising the first set of candidate content items; and
presenting, via the client device, the first content item.

2. The method of claim 1, wherein determining the second set of items comprises:
analyzing user activity information associated with the user to determine that the user is associated with an event in which at least one of:
an internet resource associated with the first item is accessed; or
the first item is added to a shopping cart; and
including the first item in the second set of items based upon the determination that the user is associated with the event.

3. The method of claim 1, wherein determining the first set of items related to the first item comprises:
generating, based upon the first item information, an item name associated with the first item;
selecting, from the plurality of items associated with the entity, a third set of items associated with the item name; and
selecting, from the third set of items, the first set of items.

4. The method of claim 3, wherein selecting the third set of items comprises:
including a second item, of the plurality of items, in the third set of items based upon a determination that a second item name associated with the second item matches the item name associated with the first item.

5. The method of claim 3, wherein:
generating the item name based upon the first item information is performed using a sequence to sequence model.

6. The method of claim 3, wherein the first item information comprises at least one of:
an indication of an item title of the first item; or
one or more indications of one or more attributes of the first item.

7. The method of claim 6, wherein:
the first item information comprises an indication of an item category of the first item.

8. The method of claim 3, comprising:
determining a plurality of sets of item information associated with the third set of items, wherein:
a set of item information of the plurality of sets of item information is associated with an item of the third set of items; and
selecting the first set of items from the third set of items is based upon the first item information and the plurality of sets of item information.

9. The method of claim 8, comprising:
determining a first representation of the first item based upon the first item information;
determining second representations of the third set of items based upon the plurality of sets of item information;
determining, based upon the first representation and the second representations, a set of similarity scores, wherein:
a similarity score of the set of similarity scores is associated with a similarity between the first item and an item of the third set of items; and
selecting the first set of items from the third set of items is based upon the set of similarity scores.

10. The method of claim 9, wherein selecting the first set of items from the third set of items comprises:
including a second item, of the third set of items, in the first set of items based upon a determination that a similarity score, of the set of similarity scores, associated with a similarity between the first item and the second item meets a threshold similarity score.

11. The method of claim 9, wherein:
the first set of items comprises k items; and
selecting the first set of items from the third set of items is based upon a determination that similarity scores associated with the first set of items are the highest k similarity scores of the set of similarity scores.

12. The method of claim 1, wherein:
selecting the first content item from the content items comprising the first set of candidate content items is performed in response to receiving a request for content associated with the user.

13. The method of claim 1, wherein:
the first item is at least one of a product or a service.

14. The method of claim 1, wherein:
the content items comprising the first set of candidate content items do not comprise a content item associated with the first item based upon the first item being out of stock.

15. A computing device comprising:
a processor; and
memory comprising processor-executable instructions that when executed by the processor cause performance of operations, the operations comprising:
identifying a first item of a plurality of items associated with an entity;
generating, based upon first item information associated with the first item, an item name associated with the first item;
selecting, from the plurality of items associated with the entity, a first set of items associated with the item name;
determining a plurality of sets of item information associated with the first set of items, wherein a set of item information of the plurality of sets of item information is associated with an item of the first set of items;
selecting, from the first set of items, a second set of items related to the first item based upon the first item information and the plurality of sets of item information;
determining a third set of items, of the plurality of items, targeted to a user, wherein the third set of items comprises the first item;
determining, based upon the second set of items and the third set of items, a first set of candidate content items for inclusion in an auction associated with selection of content for presentation via a client device associated with the user, wherein:
each candidate content item of the first set of candidate content items is associated with an item of the plurality of items; and
the first set of candidate content items comprises one or more content items associated with the second set of items related to the first item;
selecting, via the auction, a first content item from content items comprising the first set of candidate content items; and
presenting, via the client device, the first content item.

16. The computing device of claim 15, wherein determining the third set of items comprises:
analyzing user activity information associated with the user to determine that the user is associated with an event in which at least one of:
an internet resource associated with the first item is accessed; or
the first item is added to a shopping cart; and
including the first item in the third set of items based upon the determination that the user is associated with the event.

17. The computing device of claim 15, wherein selecting the first set of items comprises:
including a second item, of the plurality of items, in the first set of items based upon a determination that a second item name associated with the second item matches the item name associated with the first item.

18. The computing device of claim 15, the operations comprising:
determining a first representation of the first item based upon the first item information;
determining second representations of the first set of items based upon the plurality of sets of item information;
determining, based upon the first representation and the second representations, a set of similarity scores, wherein:
a similarity score of the set of similarity scores is associated with a similarity between the first item and an item of the first set of items; and
selecting the second set of items from the first set of items comprises including a second item, of the first set of items, in the second set of items based upon a determination that a similarity score, of the set of similarity scores, associated with a similarity between the first item and the second item meets a threshold similarity score.

19. A non-transitory machine readable medium having stored thereon processor-executable instructions that when executed cause performance of operations, the operations comprising:
identifying a first item, of a plurality of items, that is out of stock;
determining, based upon first item information associated with the first item, a first set of items related to the first item;
determining a second set of items, of the plurality of items, targeted to a user, wherein the second set of items comprises the first item that is out of stock;
determining, based upon the first set of items and the second set of items, a first set of candidate content items for inclusion in an auction associated with selection of content for presentation via a client device associated with the user, wherein:
each candidate content item of the first set of candidate content items is associated with an item of the plurality of items; and
the first set of candidate content items comprises one or more content items associated with the first set of items related to the first item;
selecting, via the auction, a first content item from content items comprising the first set of candidate content items; and
presenting, via the client device, the first content item.

20. The non-transitory machine readable medium of claim 19, wherein determining the second set of items comprises:
analyzing user activity information associated with the user to determine that the user is associated with an event in which at least one of:
an internet resource associated with the first item is accessed; or
the first item is added to a shopping cart; and
including the first item in the second set of items based upon the determination that the user is associated with the event.
